(19) United States
(12) Patent Application Publication
(10) Pub. No.: US 2011/0308401 A1
(43) Pub. Date: Dec. 22, 2011

(54) Device for holding citrus fruit slice and squeezing juice

(76) Inventors: Cameron Abedi Karamian, Coto de Caza, CA (US); Hongbo Li, Trabuco Canyon, CA (US)

(21) Appl. No.: 12/802,917

(22) Filed: Jun. 17, 2010

(51) Int. Cl. A23N 1/00

(52) U.S. Cl. 99/506

(57) ABSTRACT

A device is designed for holding citrus fruit slice and squeezing juice have two disk members dimensioned to have a common edge whereby each disk is movable to each other, said common edge having slots to position said device for supporting thereof on the rim of a receptacle. Said common edge also has outlet openings for dispensing juice upon squeezing. One of the said disk members having a sidewall member positioned on the side of said disk opposite to said common edge to form a wedge-shaped container. The sidewall member and the disk member without wall member have gripping handles. The disk members have groves and bumps for squeezing citrus fruit and guiding juice.

### BACKGROUND OF THE INVENTION

1. Field of the Invention

This invention relates to a device for holding citrus fruit slice and squeezing juice. It more particularly relates to a device for holding fruit slice on the rim of cup or glass, and squeezing fruit juice into the cup or glass.

2. Description of the Prior Art

A variety of citrus fruit slice squeezer are provided in the prior art. Particularly the lemon squeezer that can be positioned on the rim of glass or cup are also known in the prior art. However, the devices provided in the prior art are not easy to use, not easy to be placed on the rim of glass or cup, and is difficult to manufacture.

### BRIEF SUMMARY OF THE INVENTION

It is therefore an object of the invention is to provide an improved device for holding citrus fruit slice and squeezing juice.

Another object of the invention is to provide a device for holding citrus fruit slice and squeezing juice, which can be easily positioned on the rim of glass or cup.

Still another object of the invention is to provide a device for holding citrus fruit slice and squeezing juice, which can be manufactured economically.

According to the present invention, the device for holding citrus fruit slice and squeezing juice is designed to have two disk members dimensioned to have a common edge whereby each disk is movable to each other, said common edge has a slot to position said device for supporting thereof on the rim of a receptacle. Said common edge also has outlet openings for dispensing juice upon squeezing. One of the said disk members having a sidewall member positioned on the side of said disk opposite to said common edge to form a wedge-shaped container. The sidewall member and the disk member without wall member have gripping handles. The disk members have groves and bumps for squeezing citrus fruit and guiding juice.

### BRIEF DESCRIPTION OF THE SEVERAL VIEWS OF THE DRAWING

FIG. 1 is a perspective view of the preferred embodiment of the present invention in the open position;

### DESCRIPTION OF THE PREFERRED EMBODIMENT

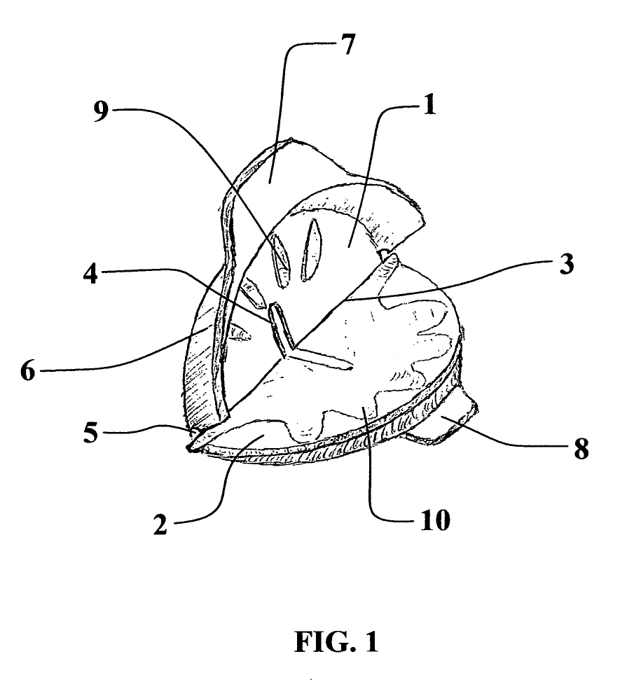

Referring to FIG. 1, the present invention is designed to have disk member 1 and disk member 2. Disk member 1 and disk member 2 have a common edge 3, which works as a hinge so that each of disk members is movable to each other. The common edge 3 has a slot 4 to position the present device on the rim of a receptacle, such as a cup or glass. The common edge 3 also has outlet openings 5 for dispensing juice upon squeezing. Disk member 1 also has a sidewall 6 positioned on the side of disk member 1 opposite to the common edge 3. Sidewall 6 and disk member 1 forms a wedge-shaped container for holding fruit slice. Disk member 1 also has gripping handle 7 and disk member 2 has gripping handle 8. In order to guide juice upon squeezing, disk member 1 is designed to have bumps 9 and disk member 2 is designed to have groves 10.

We claim:

1. A device for holding citrus fruit slice and squeezing juice comprising two disk members dimensioned to have a common edge whereby each disk is movable to each other, said common edge having slots to position said device for supporting thereof on the rim of a receptacle.

2. The device of claim 1, one of the said disk members having a sidewall member positioned on the side of said disk opposite to said common edge to form a wedge-shaped container.

3. The device of claim 1, said common edge having outlet openings for dispensing juice upon squeezing.

4. The device of claim 2, said sidewall member and the disk member without wall member having gripping handles.

5. The device of claim 1, said disk members having groves for guiding juice.

6. The device of claim 1, said disk members having bumps for squeezing citrus fruit.
